(19) United States
(12) Patent Application Publication
(10) Pub. No.: US 2026/0130535 A1
(43) Pub. Date: May 14, 2026

(54) Cold Brew Percolator Device

(71) Applicant: Randall Bland, San Diego, CA (US)

(72) Inventor: Randall Bland, San Diego, CA (US)

(21) Appl. No.: 19/032,188

(22) Filed: Jan. 20, 2025

Related U.S. Application Data
(60) Provisional application No. 63/652,258, filed on May 28, 2024.

(51) Int. Cl. A47J 31/057; A23F 5/26; A47J 31/44; A47J 31/46; F28F 1/00

(52) U.S. Cl. CPC A47J 31/057; A23F 5/262; A47J 31/4407; A47J 31/4428; A47J 31/4457; A47J 31/46; F28F 1/006; A47J 2203/00

(57) ABSTRACT

A cold brew percolator device is disclosed, which is designed to make cold brew coffee without ice or external cooling elements. The cold brew percolator device comprises a housing component that is configured in a cylindrical shape which uses a series of spinning coils powered by an electromagnetic motor to circulate the liquid and speed up heat dissipation during the brewing process. The housing component comprises removable wooden flavor filters, a continuous sprinkle head, brew and level indicator windows, and an external tap with a drip tray for easy serving.

### CROSS-REFERENCE TO RELATED APPLICATION

The present application claims priority to, and the benefit of, U.S. Provisional Application No. 63/652,258, which was filed on May 28, 2024, and is incorporated herein by reference in its entirety.

### FIELD OF THE INVENTION

The present invention relates generally to the field of cold brew percolator devices. More specifically, the present invention relates to a cold brew coffee brewing device that does not require refrigeration or ice during the cooling process of brewing. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in cold brew percolator devices. Generally, brewing cold-brew coffee often requires chilling the brew in a refrigerator or using ice to achieve cooling. This process is slow and inefficient.

Although coffee is traditionally brewed in hot or boiling water, it is also possible to cold brew coffee. A preference for cold brewed coffee has developed, principally due to its flavor. Since many of the bitter oils and acids contained in coffee are soluble only at high temperatures, coffee brewed with hot or boiling water is characterized by a harsh acrid taste. Cold brewed coffee avoids this problem. As the preference for cold brewed coffee has grown, several developments in the cold brew process have been made.

Accordingly, there is a demand for an improved cold brew percolator device that does not require refrigeration or ice during the cooling process of brewing. More particularly, there is a demand for a cold brew percolator device that is a self-cooling coffee machine that uses a series of spinning coils to circulate liquid and speed up the dissipation of heat when brewing cold coffee.

Therefore, there exists a long-felt need in the art for a cold brew percolator device that provides users with a device that does not require refrigeration or ice during the cooling process of brewing. There is also a long-felt need in the art for a cold brew percolator device that uses a series of spinning coils powered by an electromagnetic motor to circulate the liquid and speed up heat dissipation during the brewing process. Further, there is a long-felt need in the art for a cold brew percolator device that utilizes removable wooden filters. Moreover, there is a long-felt need in the art for a device that includes a continuous sprinkle head. Further, there is a long-felt need in the art for a cold brew percolator device that comprises an external tap and drip tray for easily serving the brewed coffee. Finally, there is a long-felt need in the art for a cold brew percolator device that includes brew and level indicator windows.

The subject matter disclosed and claimed herein, in one embodiment thereof, comprises a cold brew percolator device. The device is a cold brew percolator designed to make cold brew coffee without ice or external cooling elements. The cold brew percolator device comprises a housing component that is configured in a cylindrical shape which uses a series of spinning coils powered by an electromagnetic motor to circulate the liquid and speed up heat dissipation during the brewing process. The housing component comprises removable wooden flavor filters, a continuous sprinkle head, brew and level indicator windows, and an external tap with a drip tray for easy serving.

In this manner, the cold brew percolator device of the present invention accomplishes all of the foregoing objectives and provides users with a device that does not require refrigeration or ice during the cooling process of brewing. The device is a cold brew percolator device that is easy to use and features removable wooden filters. The device has an external tap for serving the brewed coffee easily.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cold brew percolator device. The device is a cold brew percolator designed to make cold brew coffee without ice or external cooling elements. The cold brew percolator device comprises a housing component which uses a series of spinning coils powered by an electromagnetic motor to circulate the liquid and speed up heat dissipation during the brewing process. The housing component comprises removable wooden flavor filters, a continuous sprinkle head, brew and level indicator windows, and an external tap with a drip tray for easy serving.

In one embodiment, the cold brew percolator device does not require refrigeration or ice during the cooling process of brewing. The cold brew percolator device is capable of making cold brewed coffee, without the need for cooling the coffee afterwards via ice or refrigeration. The cold brew percolator device is sized and shaped to sit on a countertop or table.

In one embodiment, the cold brew percolator device comprises a housing component configured in a cylindrical shape with an open water-tight cavity. The housing component has a closed bottom end and an open top end with allows access to the open water-tight cavity. A movable lid, secured by a hinge seals the water-tight cavity when not in use. In one embodiment, the cold brew percolator device can be available in different sizes depending on the wants and/or needs of a user.

In one embodiment, the open water-tight cavity is segmented into two compartments with a water compartment at the bottom of the housing component and a cold brew compartment positioned directly above the water compartment and separated by an elastomeric seal and the electromagnet spinner motor. Further, the housing component comprises a water level indicator window on the bottom to allow a user to see the water level within the housing component and a cold brew indicator window at the top to allow a user to see the cold brew level within the housing component. An inner shaft is positioned within the housing component and allows users to fill water into the water compartment for use.

In one embodiment, the housing component comprises a plurality of percolator cooling coils mounted to a central collar, such that the plurality of percolator cooling coils spin about the central collar. Typically, there are four percolator cooling coils but any suitable number of cooling coils can be utilized as is known in the art. The percolator cooling coils are in communication with an electromagnet spinner motor, which acts to spin the percolator cooling coils during use. Thus, the plurality of percolator cooling coils spin via the electromagnetic motor, similar to a milk foamer. The plurality of spinning percolator cooling coils powered by the electromagnetic motor act to circulate the liquid within the housing component and speed up heat dissipation during the brewing process.

In one embodiment, the housing component comprises wooden flavor filters which are positioned within a coffee grounds compartment. The wooden flavor filters are removable after use and disposed of. In use, the wooden flavor filters are positioned within the coffee grounds compartment and the coffee grounds are positioned on top of the flavor filter. Thus, the wooden flavor filters contact the coffee grounds during brewing and act to impart a specific flavor to the brewed coffee. The wooden flavor filters are available in different flavors, as desired by a user, in order to produce a variety of different flavor profiles.

In one embodiment, the housing component comprises a continuous sprinkle head and an Archimedes screw which acts to move the fluid within the water-tight cavity. Specifically, the bottom of the cavity contains an Archimedes screw motor, which is in communication with the Archimedes screw to rotate the screw during use. During rotation of the screw, water is drawn up from the water cavity to interact with the coffee grounds to brew coffee within the device.

In one embodiment, the housing component comprises an external tap which contacts the cold brew compartment. The external tap allows user to dispense cold brew from the device, as needed. Further, the housing component also comprises a drip tray to prevent messes and leaks when dispensing cold brew from the device.

In one embodiment, the cold brew percolator device comprises an electrical cord which is plugged into a standard wall receptacle for use, to power the device. Further, the device comprises an on/off power switch that is accessible on the housing component.

In operation, water is poured into the inner shaft to fill the water compartment within the housing component. A wooden flavor filter is then inserted into the coffee grounds compartment and coffee grounds are placed on top. The remaining internal components are assembled within the housing component and the lid is then closed. Further, the device is plugged-in and turned on for use. The water from the water compartment is drawn up via rotation of the Archimedes screw and percolates through the coffee grounds in the coffee grounds compartment. As the coffee is brewing, the plurality of percolator cooling coils spin via the electromagnetic motor. The spinning coils circulate the liquid and speed up heat dissipation during the brewing process, resulting in cold brew which can be dispensed via the external tap into a cup or glass, as needed. Once the cold brew has been dispensed, the entire device can be disassembled and cleaned, as needed.

In yet another embodiment, the cold brew percolator device comprises a plurality of indicia.

In yet another embodiment, a method of making cold brew coffee without ice or external cooling elements is disclosed. The method includes the steps of providing a cold brew percolator device comprising a housing component with a series of spinning coils powered by an electromagnetic motor. The method also comprises inserting coffee grounds into the coffee grounds compartment. Further, the method comprises filling the inner shaft with water and brewing coffee. The method also comprises spinning the coils powered by the electromagnetic motor to circulate the liquid within the device and to dissipate heat during the brewing process. Finally, the method comprises dispensing the brewed coffee via the external tap.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the cold brew percolator device of the present invention in accordance with the disclosed architecture;

FIG. 2 illustrates a perspective view of one embodiment of the cold brew percolator device of the present invention showing the external tap with a drip tray in accordance with the disclosed architecture;

FIG. 3 illustrates a perspective view of one embodiment of the cold brew percolator device of the present invention showing the housing component in accordance with the disclosed architecture;

FIG. 4 illustrates a perspective view of one embodiment of the cold brew percolator device of the present invention showing the internal cavity of the housing component in accordance with the disclosed architecture;

FIG. 5 illustrates a perspective view of one embodiment of the cold brew percolator device of the present invention showing the sprinkle head and Archimedes screw in accordance with the disclosed architecture;

FIG. 6 illustrates a perspective view of one embodiment of the cold brew percolator device of the present invention showing the internal components of the device in accordance with the disclosed architecture;

FIG. 7 illustrates a perspective view of one embodiment of the cold brew percolator device of the present invention showing the wooden flavor filters of the device in accordance with the disclosed architecture;

FIGS. 8A-C illustrate a perspective view of one embodiment of the cold brew percolator device of the present invention showing the internal components in accordance with the disclosed architecture;

FIGS. 9A-C illustrate a perspective view of one embodiment of the cold brew percolator device of the present invention showing the device in use in accordance with the disclosed architecture; and

FIG. 10 illustrates a flowchart showing the method of making cold brew coffee without ice or external cooling elements in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a cold brew percolator device that provides users with a device that does not require refrigeration or ice during the cooling process of brewing. There is also a long-felt need in the art for a cold brew percolator device that uses a series of spinning coils powered by an electromagnetic motor to circulate the liquid and speed up heat dissipation during the brewing process. Further, there is a long-felt need in the art for a cold brew percolator device that utilizes removable wooden filters. Moreover, there is a long-felt need in the art for a device that includes a continuous sprinkle head. Further, there is a long-felt need in the art for a cold brew percolator device that comprises an external tap and drip tray for easily serving the brewed coffee. Finally, there is a long-felt need in the art for a cold brew percolator device that includes brew and level indicator windows.

The present invention, in one exemplary embodiment, is a novel cold brew percolator device. The device is a cold brew percolator designed to make cold brew coffee without ice or external cooling elements. The cold brew percolator device comprises a housing component that is configured in a cylindrical shape which uses a series of spinning coils powered by an electromagnetic motor to circulate the liquid and speed up heat dissipation during the brewing process. The housing component comprises removable wooden flavor filters, a continuous sprinkle head, brew and level indicator windows, and an external tap with a drip tray for easy serving. The present invention also includes a novel method of making cold brew coffee without ice or external cooling elements. The method includes the steps of providing a cold brew percolator device comprising a housing component with a series of spinning coils powered by an electromagnetic motor. The method also comprises inserting coffee grounds into the coffee grounds compartment. Further, the method comprises filling the inner shaft with water and brewing coffee. The method also comprises spinning the coils powered by the electromagnetic motor to circulate the liquid within the device and to dissipate heat during the brewing process. Finally, the method comprises dispensing the brewed coffee via the external tap.

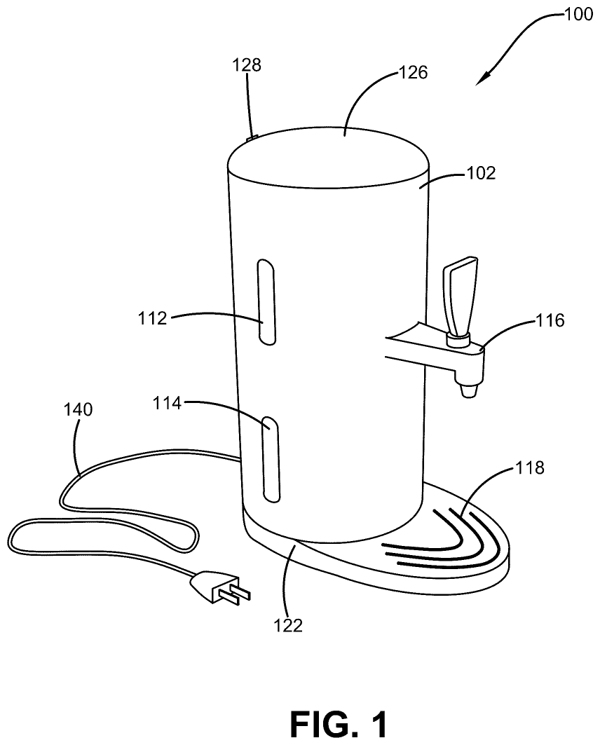

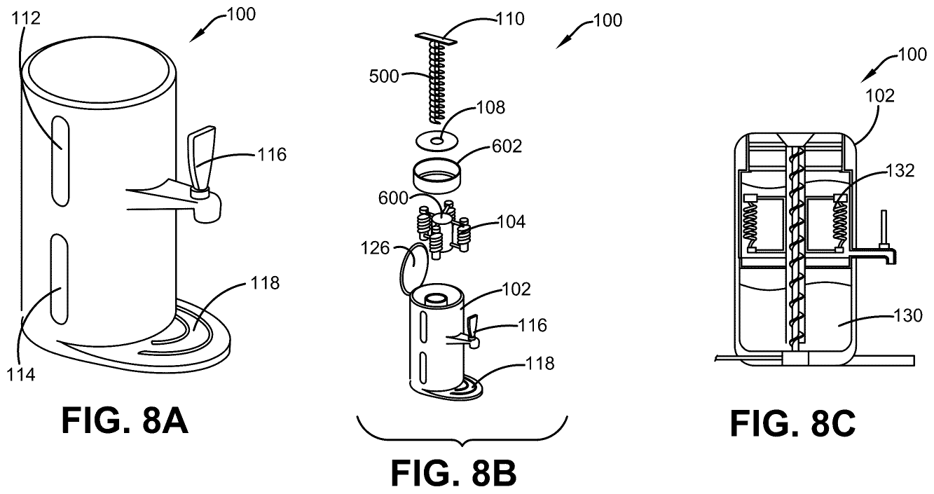

Referring initially to the drawings, FIGS. 1 and 8A-C illustrate a perspective view of one embodiment of the cold brew percolator device 100 of the present invention. In the present embodiment, the cold brew percolator device 100 is an improved cold brew percolator device 100 that provides a user with a means for making cold brew coffee without ice or external cooling elements. Specifically, the cold brew percolator device 100 comprises a housing component 102 with internal components for brewing cold brew, such as removable wooden flavor filters 108, a continuous sprinkle head 110, brew 112 and level 114 indicator windows, and an external tap 116 with a drip tray 118 for easy serving. Further, the cold brew percolator device 100 comprises a housing component 102 which uses a series of spinning coils 104 powered by an electromagnetic motor 106 to circulate the liquid and speed up heat dissipation during the brewing process.

Generally, the cold brew percolator device 100 does not require refrigeration or ice during the cooling process of brewing. The cold brew percolator device 100 is capable of making cold brewed coffee, without the need for cooling the coffee afterwards via ice or refrigeration. The cold brew percolator device 100 is sized and shaped to sit on a countertop or table.

Further, the cold brew percolator device 100 comprises a housing component 102 configured in a cylindrical shape with an open water-tight cavity 120. The housing component 102 has a closed bottom end 122 and an open top end 124 which allows access to the open water-tight cavity 120. A movable lid 126, secured by a hinge 128 seals the water-tight cavity 120 when not in use. In one embodiment, the cold brew percolator device 100 can be available in different sizes depending on the wants and/or needs of a user.

Additionally, the open water-tight cavity 120 is segmented into two compartments 130, 132 with a water compartment 130 at the bottom of the housing component 102 and a cold brew compartment 132 positioned directly above the water compartment 130 and separated by an elastomeric seal and the electromagnet spinner motor 106. Further, the housing component 102 comprises a water level indicator window 114 on the bottom to allow a user to see the water level within the housing component 102 and a cold brew indicator window 112 at the top to allow a user to see the cold brew level within the housing component 102. An inner shaft 134 is positioned within the housing component 102 and allows users to fill water 136 into the water compartment 130 for use.

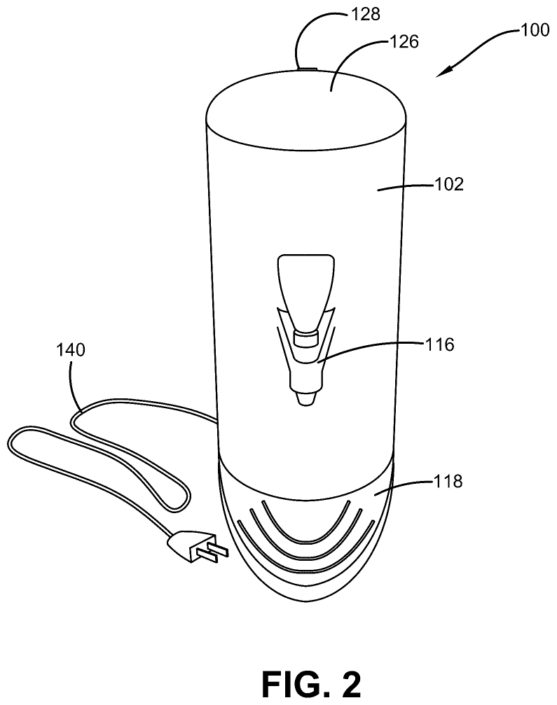

As shown in FIG. 2, the housing component 102 comprises an external tap 116 which contacts the cold brew compartment 132. The external tap 116 allows user to dispense cold brew 138 from the device 100, as needed. Further, the housing component 102 also comprises a drip tray 118 to prevent messes and leaks when dispensing cold brew 138 from the device 100.

Further, the cold brew percolator device 100 comprises an electrical cord 140 which is plugged into a standard wall receptacle for use, to power the device 100. Further, the device 100 comprises an on/off power switch 142 that is accessible on the housing component 102.

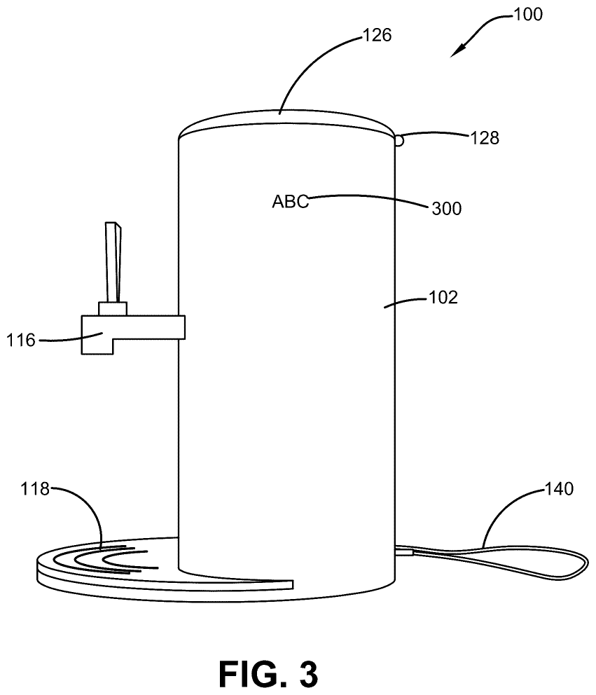

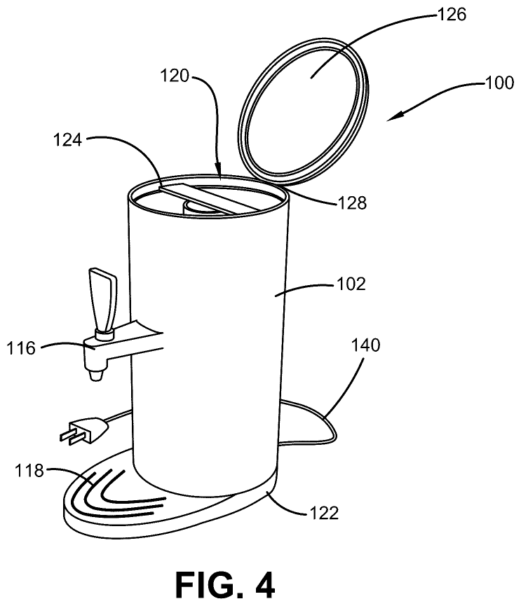

As shown in FIGS. 3-4, the cold brew percolator device 100 comprises a plurality of indicia 300. The housing component 102 of the device 100 may include advertising, a trademark, or other letters, designs, or characters, printed, painted, stamped, or integrated into the housing component 102, or any other indicia 300 as is known in the art. Specifically, any suitable indicia 300 as is known in the art can be included, such as, but not limited to, patterns, logos, emblems, images, symbols, designs, letters, words, characters, animals, advertisements, brands, etc., that may or may not be cold brew, percolator, or brand related.

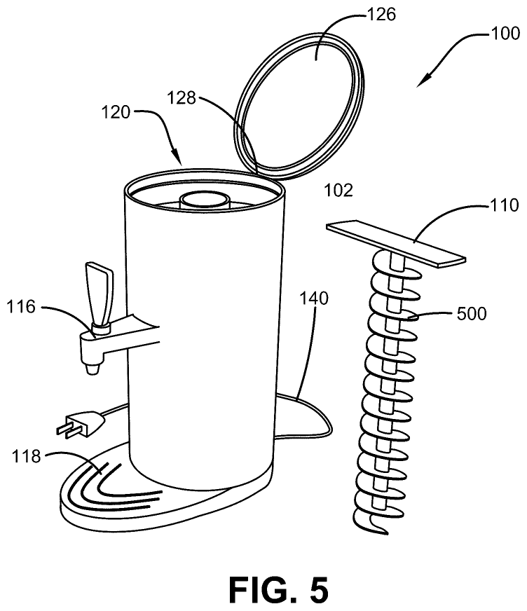

As shown in FIG. 5, the housing component 102 comprises a continuous sprinkle head 110 and an Archimedes screw 500 which acts to move the fluid within the water-tight cavity 120. Specifically, the bottom of the cavity 120 contains an Archimedes screw motor 502, which is in communication with the Archimedes screw 500 to rotate the screw 500 during use. During rotation of the screw 500, water 136 is drawn up from the water cavity 130 to interact with the coffee grounds to brew coffee within the device 100.

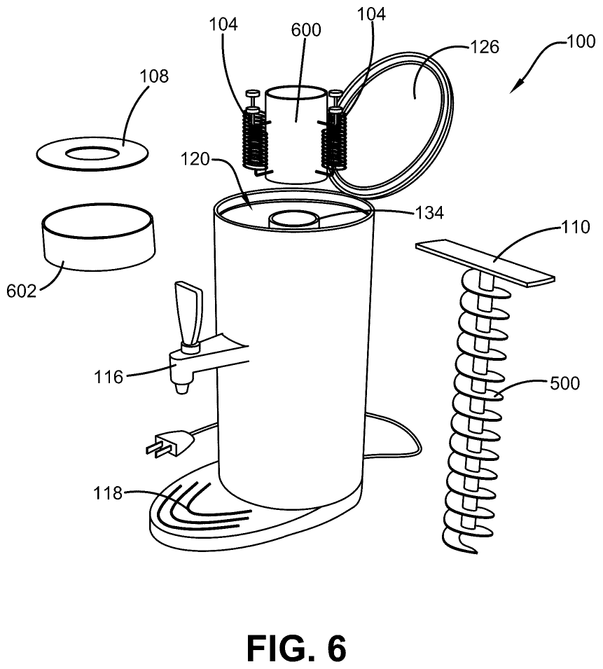

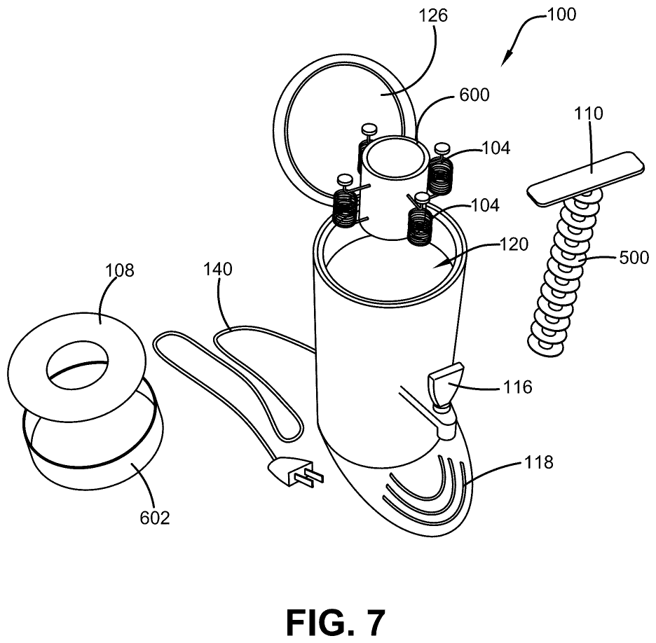

As shown in FIGS. 6-7, the housing component 102 comprises a plurality of percolator cooling coils 104 mounted to a central collar 600, such that the plurality of percolator cooling coils 104 spin about the central collar 600. Typically, there are four percolator cooling coils 104 but any suitable number of cooling coils 104 can be utilized as is known in the art. The percolator cooling coils 104 are in communication with an electromagnet spinner motor 106, which acts to spin the percolator cooling coils 104 during use. Thus, the plurality of percolator cooling coils 104 spin via the electromagnetic motor 106, similar to a milk foamer. The plurality of spinning percolator cooling coils 104 powered by the electromagnetic motor 106 act to circulate the liquid within the housing component 102 and speed up heat dissipation during the brewing process.

Further, the housing component 102 comprises wooden flavor filters 108 which are positioned within a coffee grounds compartment 602. The wooden flavor filters 108 are removable after use and disposed of. In use, the wooden flavor filters 108 are positioned within the coffee grounds compartment 602, and coffee grounds are positioned on top of the flavor filter 108. Thus, the wooden flavor filters 108 contact the coffee grounds during brewing and act to impart a specific flavor to the brewed coffee. The wooden flavor filters 108 are available in different flavors, as desired by a user, in order to produce a variety of different flavor profiles.

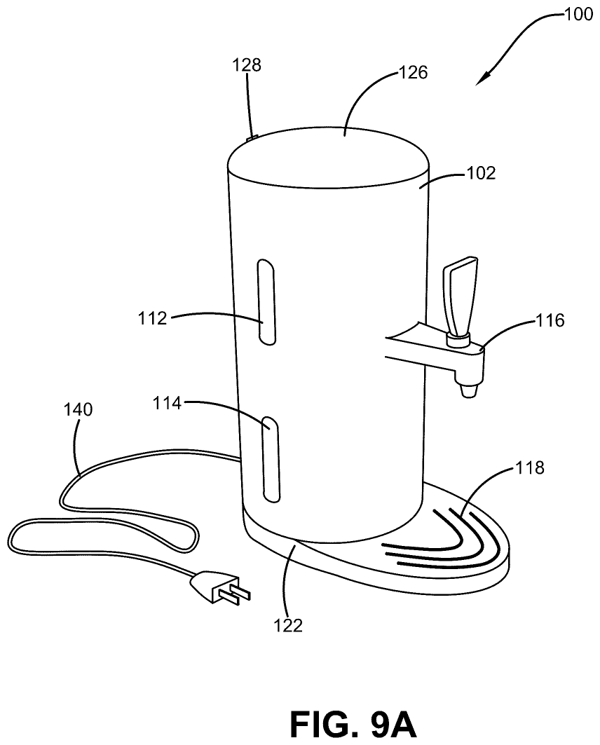

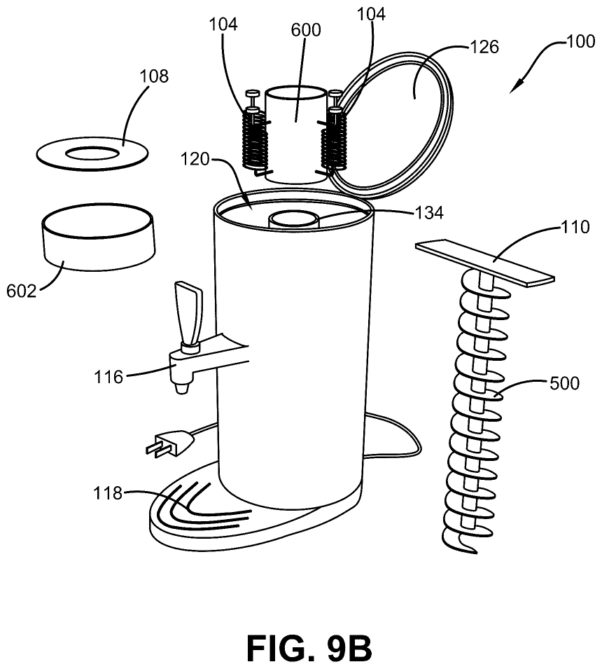

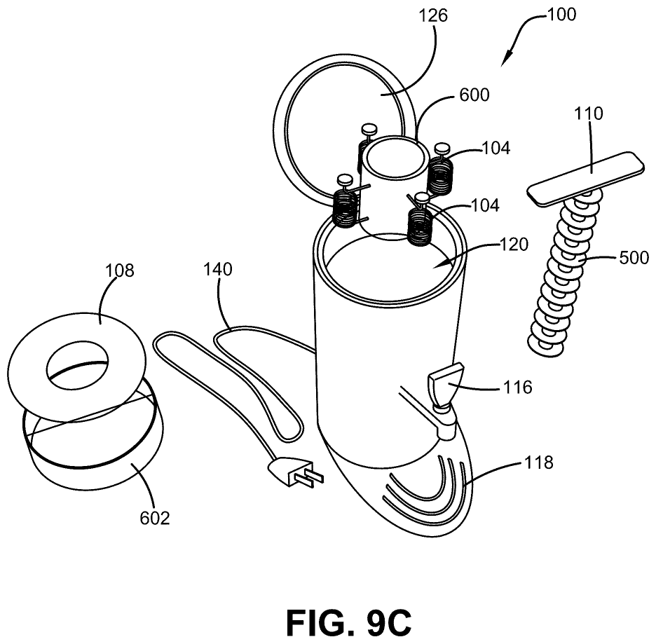

As shown in FIGS. 9A-C, in operation, water 136 is poured into the inner shaft 134 to fill the water compartment 130 within the housing component 102. A wooden flavor filter 108 is then inserted into the coffee grounds compartment 602 and coffee grounds are placed on top. The remaining internal components are assembled within the housing component 102 and the lid 126 is then closed. Further, the device 100 is plugged-in and turned on for use. The water 136 from the water compartment 130 is drawn up via rotation of the Archimedes screw 500 and percolates through the coffee grounds in the coffee grounds compartment 602. As the coffee is brewing, the plurality of percolator cooling coils 104 spin via the electromagnetic motor 106. The spinning coils 104 circulate the liquid and speed up heat dissipation during the brewing process, resulting in cold brew 138 which can be dispensed via the external tap 116 into a cup or glass, as needed. Once the cold brew 138 has been dispensed, the entire device 100 can be disassembled and cleaned, as needed.

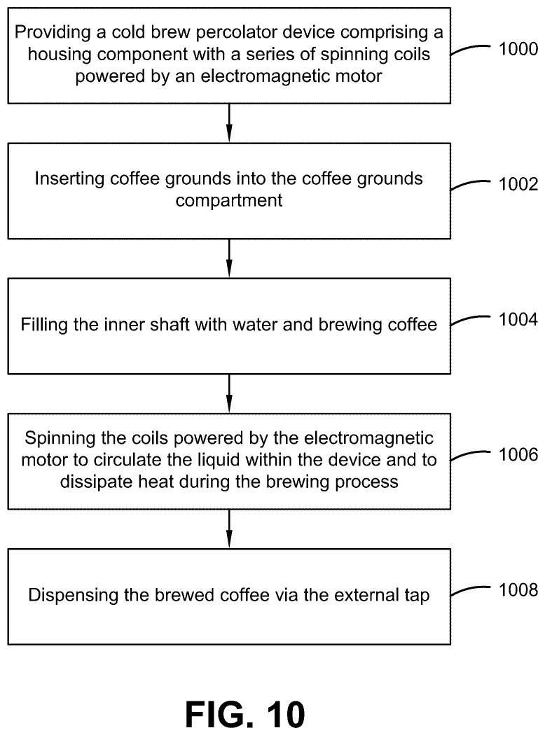

FIG. 10 illustrates a flowchart of the method of making cold brew coffee without ice or external cooling elements. The method includes the steps of at 1000, providing a cold brew percolator device comprising a housing component with a series of spinning coils powered by an electromagnetic motor. The method also comprises at 1002, inserting coffee grounds into the coffee grounds compartment. Further, the method comprises at 1004, filling the inner shaft with water and brewing coffee. The method also comprises at 1006, spinning the coils powered by the electromagnetic motor to circulate the liquid within the device and to dissipate heat during the brewing process. Finally, the method comprises at 1008, dispensing the brewed coffee via the external tap.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “cold brew percolator device”, “cold brew device”, “percolator device”, and “device” are interchangeable and refer to the cold brew percolator device 100 of the present invention.

Notwithstanding the foregoing, the cold brew percolator device 100 of the present invention can be of any suitable size and configuration as is known in the art without affecting the overall concept of the invention, provided that it accomplishes the above-stated objectives. One of ordinary skill in the art will appreciate that the cold brew percolator device 100 as shown in FIGS. 1-10 is for illustrative purposes only, and that many other sizes and shapes of the cold brew percolator device 100 are well within the scope of the present disclosure. Although the dimensions of the cold brew percolator device 100 are important design parameters for user convenience, the cold brew percolator device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cold brew percolator device that provides a user with a means for making cold brew coffee without ice or external cooling elements, the cold brew percolator device comprising:
a housing component;
wherein the housing component is configured in a cylindrical shape with an open water-tight cavity with internal components for percolating coffee; and
further wherein the housing component uses a plurality of cooling coils to circulate liquid and speed up heat dissipation during brewing process to make cold brew without need for cooling coffee afterwards via ice or refrigeration.

2. The cold brew percolator device of claim 1, wherein the housing component has a closed bottom end and an open top end which allows access to the open water-tight cavity.

3. The cold brew percolator device of claim 2, wherein the water-tight cavity is secured by a movable lid, secured by a hinge.

4. The cold brew percolator device of claim 3, wherein the open water-tight cavity is segmented into two compartments, a water compartment at a bottom of the housing component and a cold brew compartment positioned directly above the water compartment and separated by an elastomeric seal.

5. The cold brew percolator device of claim 4, wherein the housing component comprises a water level indicator window on the bottom.

6. The cold brew percolator device of claim 5, wherein the housing comprises a cold brew indicator window at a top.

7. The cold brew percolator device of claim 6, wherein an inner shaft is positioned within the housing component and allows users to fill water into the water compartment for use.

8. The cold brew percolator device of claim 7, wherein the housing component comprises an external tap to dispense cold brew and a drip tray to prevent messes.

9. The cold brew percolator device of claim 8, wherein the housing component comprises a continuous sprinkle head and an Archimedes screw which acts to move fluid within the open water-tight cavity.

10. The cold brew percolator device of claim 9, wherein a bottom of the open water-tight cavity contains an Archimedes screw motor, which is in communication with the Archimedes screw to rotate the Archimedes screw during use.

11. The cold brew percolator device of claim 10, wherein the housing component comprises a plurality of percolator cooling coils mounted to a central collar, such that the plurality of percolator cooling coils spin about the central collar.

12. The cold brew percolator device of claim 11, wherein the plurality of percolator cooling coils are in communication with an electromagnet spinner motor, which acts to spin the plurality of percolator cooling coils during use.

13. The cold brew percolator device of claim 12, wherein the housing component comprises wooden flavor filters which are positioned within a coffee grounds compartment.

14. A cold brew percolator device that provides a user with a means for making cold brew coffee without ice or external cooling elements, the cold brew percolator device comprising:
a housing component configured in a cylindrical shape with an open water-tight cavity and having a closed bottom end and an open top end with allows access to the open water-tight cavity; wherein the water-tight cavity is secured by a movable lid, secured by a hinge;
wherein the open water-tight cavity is segmented into two compartments, a water compartment at a bottom of the housing component and a cold brew compartment positioned directly above the water compartment and separated by an elastomeric seal;
wherein the housing component comprises a water level indicator window and a cold brew indicator window;
wherein an inner shaft is positioned within the housing component and allows users to fill water into the water compartment for use;
wherein the housing component comprises an external tap to dispense cold brew and a drip tray to prevent messes;
wherein the housing component comprises a continuous sprinkle head and an Archimedes screw which acts to move fluid within the open water-tight cavity;
wherein the housing component comprises a plurality of percolator cooling coils mounted to a central collar, such that the plurality of percolator cooling coils spin about the central collar;
wherein the plurality of percolator cooling coils are in communication with an electromagnet spinner motor, which acts to spin the plurality of percolator cooling coils during use to speed up heat dissipation during brewing process to make cold brew without need for cooling coffee afterwards via ice or refrigeration; and
further wherein the housing component comprises wooden flavor filters which are positioned within a coffee grounds compartment.

15. The cold brew percolator device of claim 14 further comprising a plurality of indicia.

16. The cold brew percolator device of claim 14, wherein the cold brew percolator device is available in different sizes.

17. The cold brew percolator device of claim 14, wherein the housing component comprises an electrical cord for power.

18. The cold brew percolator device of claim 14, wherein the electrical cord is plugged into a standard wall receptacle for use, to power the cold brew percolator device.

19. The cold brew percolator device of claim 14, wherein the housing component comprises an on/off power switch.

20. A method of making cold brew coffee without ice or external cooling elements, the method comprising the following steps:
providing a cold brew percolator device comprising a housing component with a series of spinning coils powered by an electromagnetic motor;
inserting coffee grounds into the coffee grounds compartment;
filling the inner shaft with water and brewing coffee;
spinning the coils powered by the electromagnetic motor to circulate the liquid within the device and to dissipate heat during the brewing process; and
dispensing the brewed coffee via the external tap.
